(19) United States
(12) Patent Application Publication
(10) Pub. No.: US 2014/0043329 A1
(43) Pub. Date: Feb. 13, 2014

(54) METHOD OF AUGMENTED MAKEOVER WITH 3D FACE MODELING AND LANDMARK ALIGNMENT

(71) Applicants: Peng Wang, Beijing (CN); Yimin Zhang, Beijing (CN)

(72) Inventors: Peng Wang, Beijing (CN); Yimin Zhang, Beijing (CN)

(21) Appl. No.: 13/997,327

(22) PCT Filed: Mar. 21, 2011
(86) PCT No.: PCT/CN2011/000451

§ 371 Date: Oct. 3, 2013

(51) Int. Cl. G06T 17/10

(52) U.S. Cl. CPC G06T 17/10
USPC 345/420

(57) ABSTRACT

Generation of a personalized 3D morphable model of a user's face may be performed first by capturing a 2D image of a scene by a camera. Next, the user's face may be detected in the 2D image and 2D landmark points of the user's face may be detected in the 2D image. Each of the detected 2D landmark points may be registered to a generic 3D face model. Personalized facial components may be generated in real time to represent the user's face mapped to the generic 3D face model to form the personalized 3D morphable model. The personalized 3D morphable model may be displayed to the user. This process may be repeated in real time for a live video sequence of 2D images from the camera.

### FIELD

The present disclosure generally relates to the field of image processing. More particularly, an embodiment of the invention relates to augmented reality applications executed by a processor in a processing system for personalizing facial images.

### BACKGROUND

Face technology and related applications are of great interest to consumers in the personal computer (PC), handheld computing device, and embedded market segments. When a camera is used as the input device to capture the live video stream of a user, there are extensive demands to view, analyze, interact, and enhance a user's face in the “mirror” device. Existing approaches to computer-implemented face and avatar technologies fall into four distinct major categories. The first category characterizes facial features using techniques such as local binary patterns (LBP), a Gabor filter, scale-invariant feature transformations (SIFT), speeded up robust features (SURF), and a histogram of oriented gradients (HOG). The second category deals with a single two dimensional (2D) image, such as face detection, facial recognition systems, gender/race detection, and age detection. The third category considers video sequences for face tracking, landmark detection for alignment, and expression rating. The fourth category models a three dimensional (3D) face and provides animation.

In most current solutions, user interaction in the face related applications is based on a 2D image or video. In addition, the entire face area is the target of the user interaction. One disadvantage of current solutions is that the user cannot interact with a partial face area or individual feature nor operate on a natural 3D space. Although there are a small number of applications which could present the user with a 3D face model, a generic model is usually provided. These applications lack the ability for customization and do not provide for an immersive experience for the user. A better approach, ideally one that combines all four capabilities (facial features, 2D face detection, face tracking in video sequences and landmark detection for alignment, and 3D face animation) in a single processing system, is desired.

### BRIEF DESCRIPTION OF THE DRAWINGS

The detailed description is provided with reference to the accompanying figures. The use of the same reference numbers in different figures indicates similar or identical items.

FIG. 1 is a diagram of an augmented reality component in accordance with some embodiments of the invention.

FIG. 2 is a diagram of generating personalized facial components for a user in an augmented reality component in accordance with some embodiments of the invention.

FIGS. 3 and 4 are example images of face detection processing according to an embodiment of the present invention.

FIG. 5 is an example of the possibility response image and its smoothed result when applying a cascade classifier of the left corner of a mouth on a face image according to an embodiment of the present invention.

FIG. 6 is an illustration of rotational, translational, and scaling parameters according to an embodiment of the present invention.

FIG. 7 is a set of example images showing a wide range of face variation for landmark points detection processing according to an embodiment of the present invention.

FIG. 8 is an example image showing 95 landmark points on a face according to an embodiment of the present invention.

FIGS. 9 and 10 are examples of 2D facial landmark points detection processing performed on various face images according to an embodiment of the present invention.

FIG. 11 are example images of landmark points registration processing according to an embodiment of the present invention.

FIG. 12 is an illustration of a camera model according to an embodiment of the present invention.

FIG. 13 illustrates a geometric re-projection error according to an embodiment of the present invention.

FIG. 14 illustrates the concept of filtering according to an embodiment of the present invention.

FIG. 15 is a flow diagram of a texture mapping framework according to an embodiment of the present invention.

FIGS. 16 and 17 are example images illustrating 3D face building from multi-views images according to an embodiment of the present invention.

FIGS. 18 and 19 illustrate block diagrams of embodiments of processing systems, which may be utilized to implement some embodiments discussed herein.

### DETAILED DESCRIPTION

Embodiments of the present invention provide for interaction with and enhancement of facial images within a processor-based application that are more “fine-scale” and “personalized” than previous approaches. By “fine-scale”, the user could interact with and augment individual face features such as eyes, mouth, nose, and cheek, for example. By “personalized”, this means that facial features may be characterized for each human user rather than be restricted to a generic face model applicable to everyone. With the techniques that are proposed in embodiments of this invention, advanced face and avatar applications may be enabled for various market segments of processing systems.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean either hardware, software (including for example micro-code that controls the operations of a processor), firmware, or some combination thereof.

Embodiments of the present invention process a user's face images captured from a camera. After fitting the face image to a generic 3D face model, embodiments of the present invention facilitate interaction by an end user with a personalized avatar 3D model of the user's face. With the landmark mapping from a 2D face image to a 3D avatar model, primary facial features such as eyes, mouth, and nose may be individually characterized. By this means, advanced Human Computer Interaction (HCI) interactions, such as a virtual makeover, may be provided that is more natural and immersive than previous techniques.

To provide a user with a customized facial representation, embodiments of the present invention present the user with a 3D face avatar which is a morphable model, not a generic unified model. To facilitate the capability for the user to individually and separately enhance and/or augment their eyes, nose, mouth, and/or cheek, or other facial features on the 3D face avatar model, embodiments of the present invention extract a group of landmark points whose geometry and texture constraints are robust across people. To provide the user with a dynamic interactive experience, embodiments of the present invention map the captured 2D face image to the 3D face avatar model for facial expression synchronization.

A generic 3D face model is a 3D shape representation describing the geometry attributes of a human face having a neutral expression. It usually consists of a set of vertices, edges connecting between two vertices, and a closed set of three edges (triangle face) or four edges (quad face).

To present the personalized avatar in a photo-realistic model, a multi-view stereo component based on a 3D model reconstruction may be included in embodiments of the present invention. The multi-view stereo component processes N face images (or consecutive frames in a video sequence), where N is a natural number, and automatically estimates the camera parameters, point cloud, and mesh of a face model. A point cloud is a set of vertices in a three-dimensional coordinate system. These vertices are usually defined by X, Y, and Z coordinates, and typically are intended to be representative of the external surface of an object.

To separately interact with a partial face area, a monocular landmark detection component may be included in embodiments of the present invention. The monocular landmark detection component aligns a current video frame with a previous video frame and also registers key points to the generic 3D face model to avoid drifting and littering. In an embodiment, when the mapping distances for a number of landmarks are larger than a threshold, detection and alignment of landmarks may be automatically restarted.

To augment the personalized avatar by taking advantage of the generic 3D face model. Principle Component Analysis may be included in embodiments of the present invention. Principle Component Analysis (PCA) transforms the mapping of typically thousands of vertices and triangles into a mapping of tens of parameters. This makes the computational complexity feasible if the augmented reality component is executed on a processing system comprising an embedded platform with limited computational capabilities. Therefore, real time face tracking and personalized avatar manipulation may be provided by embodiments of the present invention.

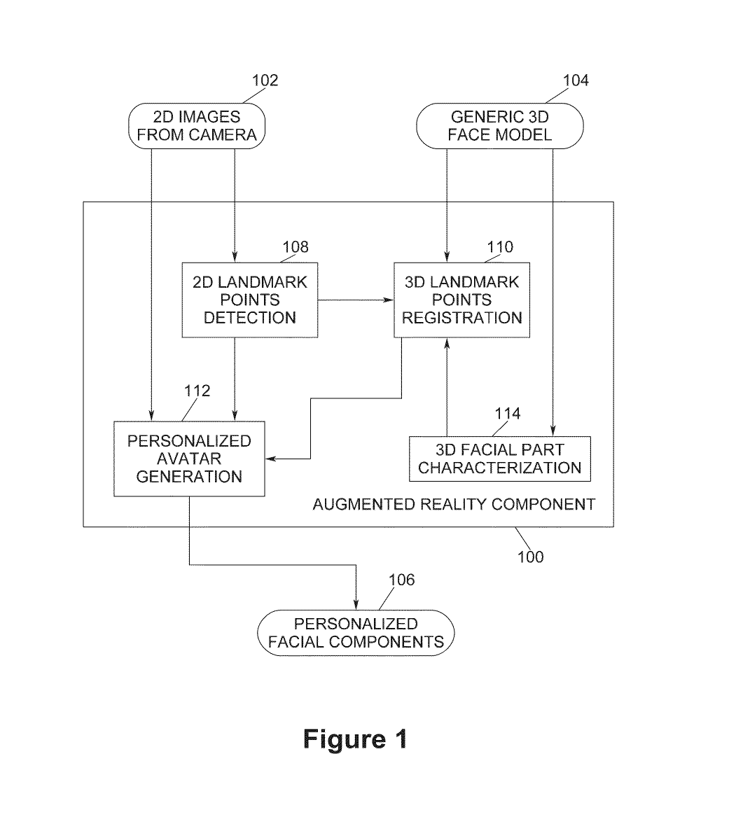

FIG. 1 is a diagram of an augmented reality component 100 in accordance with some embodiments of the invention. In an embodiment, the augmented reality component may be a hardware component, firmware component, software component or combination of one or more of hardware, firmware, and/or software components, as part of a processing system. In various embodiments, the processing system may be a PC, a laptop computer, a netbook, a tablet computer, a handheld computer, a smart phone, a mobile Internet device (MID), or any other stationary or mobile processing device. In another embodiment, the augmented reality component 100 may be a part of an application program executing on the processing system. In various embodiments, the application program may be a standalone program, or a part of another program (such as a plug-in, for example) of a web browser, image processing application, game, or multimedia application, for example.

In an embodiment, there are two data domains: 2D and 3D, represented by at least one 2D face image and a 3D avatar model, respectively. A camera (not shown), may be used as an image capturing tool. The camera obtains at least one 2D image 102. In an embodiment, the 2D images may comprise multiple frames from a video camera. In an embodiment, the camera may be integral with the processing system (such as a web cam, cell phone camera, tablet computer camera, etc.). A generic 3D face model 104 may be previously stored in a storage device of the processing system and inputted as needed to the augmented reality component 100. In an embodiment, the generic 3D face model may be obtained by the processing system over a network (such as the Internet, for example). In an embodiment, the generic 3D face model may be stored on a storage device within the processing system. The augmented reality component 100 processes the 2D images, the generic 3D face model, and optionally, user inputs in real time to generate personalized facial components 106. Personalized facial components 106 comprise a 3D morphable model representing the user's face as personalized and augmented for the individual user. The personalized facial components may be stored in a storage device of the processing system. The personalized facial components 106 may be used in other application programs, processing systems, and/or processing devices as desired. For example, the personalized facial components may be shown on a display of the processing system for viewing with, and interaction by, the user. User inputs may be obtained via well known user interface techniques to change or augment selected features of the user's face in the personalized facial components. In this way, the user may see what selected changes may look like on a personalized 3D facial model of the user, with all changes being shown in approximately real time. In one embodiment, the resulting application comprises a virtual makeover capability.

Embodiments of the present invention support at least three input cases. In the first case, a single 2D image of the user may be fitted to a generic 3D face model. In the second case, multiple 2D images of the user may be processed by applying camera pose recovery and multi-view stereo matching techniques to reconstruct a 3D model. In the third case, a sequence of live video frames may be processed to detect and track the user's face and generate and continuously adjust a corresponding personalized 3D morphable model of the user's face based at least in part on the live video frames and, optionally, user inputs to change selected individual facial features.

In an embodiment, personalized avatar generation component 112 provides for face detection and tracking, camera pose recovery, multi-view stereo image processing, model fitting, mesh refinement, and texture mapping operations. Personalized avatar generation component 112 detects face regions in the 2D images 102 and reconstructs a face mesh. To achieve this goal, camera parameters such as focal length, rotation and transformation, and scaling factors may be automatically estimated. In an embodiment, one or more of the camera parameters may be obtained from the camera. When getting the internal and external camera parameters, sparse point clouds of the user's face will be recovered accordingly. Since fine-scale avatar generation is desired, a dense point cloud for the 2D face model may be estimated based on multi-view images with a bundle adjustment approach. To establish the morphing relation between a generic 3D face model 104 and an individual user's face as captured in the 2D images 102, landmark feature points between the 2D face model and 3D face model may be detected and registered by 2D landmark points detection component 108 and 3D landmark points registration component 110, respectively.

The landmark points may be defined with regard to stable texture and spatial correlation. The more landmark points that are registered, the more accurate the facial components may be characterized. In an embodiment, up to 95 landmark points may be detected. In various embodiments, a Scale Invariant Feature Transform (SIFT) or a Speedup Robust Features (SURF) process may be applied to characterize the statistics among training face images. In one embodiment, the landmark point detection modules may be implemented using Radial Basis Functions. In one embodiment, the number and position of 3D landmark points may be defined in an offline model scanning and creation process. Since mesh information about facial components in a generic 3D face model 104 are known, the facial parts of a personalized avatar may be interpolated by transforming the dense surface.

In an embodiment, the 3D landmark points of the 3D morphable model may be generated at least in part by 3D facial part characterization module 114. The 3D facial part characterization module may derive portions of the 3D morphable model, at least in part, from statistics computed on a number of example faces and may be described in terms of shape and texture spaces. The expressiveness of the model can be increased by dividing faces into independent sub-regions that are morphed independently, for example into eyes, nose, mouth and a surrounding region. Since all faces are assumed to be in correspondence, it is sufficient to define these regions on a reference face. This segmentation is equivalent to subdividing the vector space of faces into independent subspaces. A complete 3D face is generated by computing linear combinations for each segment separately and blending them at the borders.

Suppose the geometry of a face is represented with a shape-vector S=(X₁, Y₁, Z₁, X₂, . . . , Yₙ, Zₙ)^{T} ε [symbol] ³ⁿ, that contains the X, Y, Z-coordinates of its n vertices. For simplicity, assume that the number of valid texture values in the texture map is equal to the number of vertices. T the texture of a face may be represented by a texture-vector T=(R₁, G₁, B₁, R₂, . . . , Gₙ, Bₙ) ε [symbol] ³ⁿ, that contains the R, G, color values of then corresponding vertices. The segmented morphable model would be characterized by four disjoint sets, where S(eyes)=(Xₑ₁, Yₑ₁, Zₑ₁, Xₑ₂, . . . Yₙ₁, Zₙ₁) ε [symbol] ³ⁿ¹; T(eyes)=(Rₑ₁, Gₑ₁, Bₑ₁, Rₑ₂, . . . , Gₙ₁, Bₙ₁) ε [symbol] ³ⁿ¹ describe the shape and texture vector of eye region, S(nose)=(Xₙₒ₁, Yₙₒ₁, Zₙₒ₁, Xₙₒ₂, . . . , Yₙ₂, Zₙ₂) ε [symbol] ³ⁿ²; T(nose) =CRₙₒ₁, Gₙₒ₁, Bₙₒ₁, Rₙₒ₂, . . . , Gₙ₂, Bₙ₂) ε [symbol] ³ⁿ² describe the nose region, S(mouth)=(Xₘ₁, Yₘ₁, Zₘ₁, Xₘ₂, . . . , Yₙ₃, Zₙ₃) ε [symbol] ³ⁿ³; T(mouth)=(Rₘ₁, Gₘ₁, Bₘ₁, Bₘ₂, . . . , Gₙ₃, Bₙ₃) ε [symbol] ³ⁿ³ describe the mouth region, and S(surrounding)=(Xₛ₁, Yₛ₁, Zₛ₁, Xₛ₂, . . . , Yₙ₄, Zₙ₄). ε [symbol] ³ⁿ⁴; T(surrounding)=(Rₛ₁, Gₛ₁, Bₛ₁, Rₛ₂, . . . , Gₙ₄, Bₙ₄) ε [symbol] ³ⁿ⁴ describe the surrounding region, and n=n1+n2+n3+n4, S={{S(eyes)}, {S(nose)}, {S(mouth)}, {S(surrounding)}}, and T={{T(eyes)}, {T(nose)}, {T(mouth)}, {T(surrounding)}}.

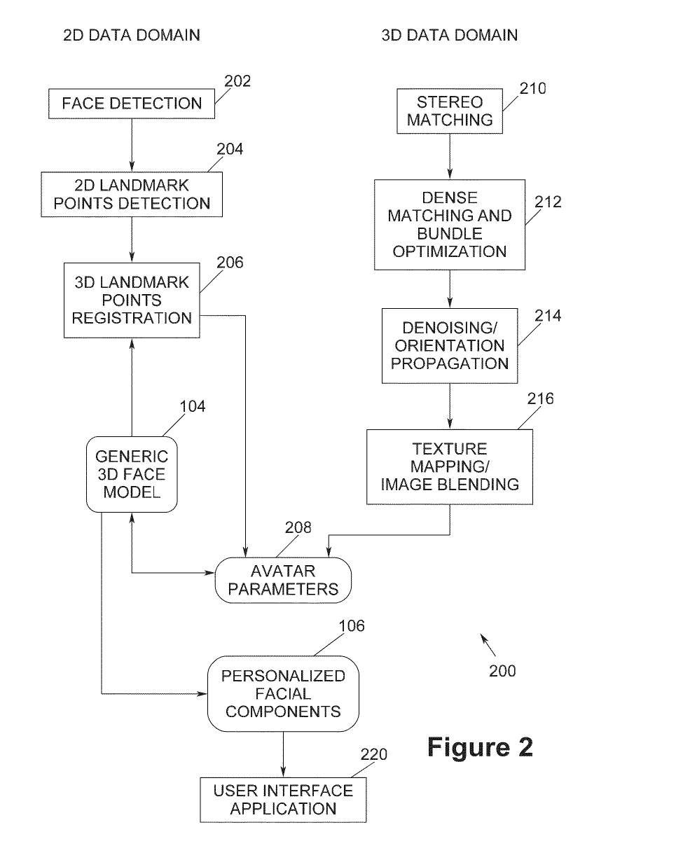

FIG. 2 is a diagram of a process 200 to generate personalized facial components 106 by an augmented reality component 100 in accordance with some embodiments of the invention. In an embodiment, the following processing may be performed for the 2D data domain.

First, face detection processing may be performed at block 202. In an embodiment, face detection processing may be performed by personalized avatar generation component 112. The input data comprises one or more 2D images (I1, . . . , In) 102. In an embodiment, the 2D images comprise a sequence of video frames at a certain frame rate fps with each video frame having an image resolution (W×H). Most existing face detection approaches follow the well known Viola-Jones framework as shown in “Rapid Object Detection Using a Boosted Cascade of Simple Features,” by Paul Viola and Michael Jones, Conference on Computer Vision and Pattern Recognition, 2001. However, based on experiments performed by the applicants, in an embodiment, use of Gabor features and a Cascade model in conjunction with the Viola-Jones framework may achieve relatively high accuracy for face detection. To improve the processing speed, in embodiments of the present invention, face detection may be decomposed into multiple consecutive frames. With such a strategy, the computational load is independent of image size. The number of faces #f, position in a frame (x, y), and size of faces in width and height (w, h) may be predicted for every video frame. Face detection processing 202 produces one or more face data sets (#f, [x, y, w, h]).

Some known face detection algorithms implement the face detection task as a binary pattern classification task. That is, the content of a given part of an image is transformed into features, after which a classifier trained on example faces decides whether that particular region of the image is a face, or not. Often, a window-sliding technique is employed. That is, the classifier is used to classify the (usually square or rectangular) portions of an image, at all locations and scales, as either faces or non-faces (background pattern).

A face model can contain the appearance, shape, and motion of faces. The Viola-Jones object detection framework is an object detection framework that provides competitive object detection rates in real-time. It was motivated primarily by the problem of face detection.

Components of the object detection framework include feature types and evaluation, a learning algorithm, and a cascade architecture. In the feature types and evaluation component, the features employed by the object detection framework universally involve the sums of image pixels within rectangular areas. With the use of an image representation called the integral image, rectangular features can be evaluated in constant time, which gives them a considerable speed advantage over their more sophisticated relatives.

In the learning algorithm component, in a standard 24×24 pixel sub-window, there are a total of 45,396 possible features, and it would be prohibitively expensive to evaluate them all. Thus, the object detection framework employs a variant of the known learning algorithm Adaptive Boosting (AdaBoost) to both select the best features and to train classifiers that use them. Adaboost is a machine learning algorithm, as disclosed by Yoav Freund and Robert Schapire in “A Decision-Theoretic Generalization of On-Line Learning and an Application to Boosting,” ATT Bell Laboratories, Sep. 20, 1995. It is a meta-algorithm, and can be used in conjunction with many other learning algorithms to improve their performance. AdaBoost is adaptive in the sense that subsequent classifiers built are tweaked in favor of those instances misclassified by previous classifiers. AdaBoost is sensitive to noisy data and outliers. However, in some problems it can be less susceptible to the overfitting problem than most learning algorithms. AdaBoost calls a weak classifier repeatedly in a series of rounds (t=1, . . . T). For each call, a distribution of weights Dₜ is updated that indicates the importance of examples in the data set for the classification. On each round, the weights of each incorrectly classified example are increased (or alternatively, the weights of each correctly classified example are decreased), so that the new classifier focuses more on those examples.

In the cascade architecture component, the evaluation of the strong classifiers generated by the learning process can be done quickly, but it isn't fast enough to run in real-time. For this reason, the strong classifiers are arranged in a cascade in order of complexity, where each successive classifier is trained only on those selected samples which pass through the preceding classifiers. If at any stage in the cascade a classifier rejects the sub-window under inspection, no further processing is performed and cascade architecture component continues searching the next sub-window.

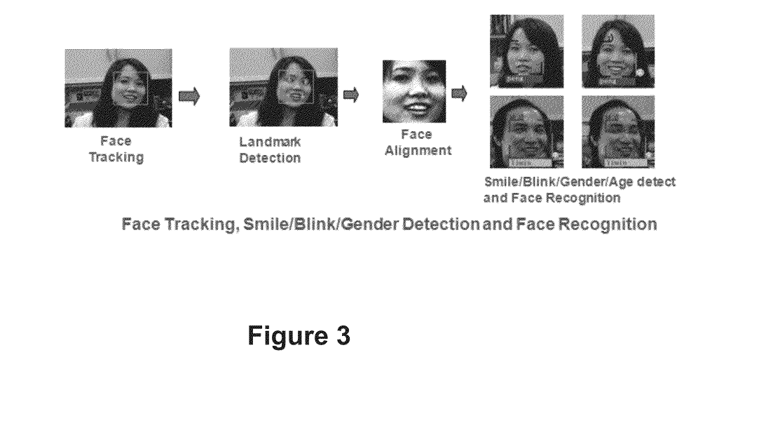

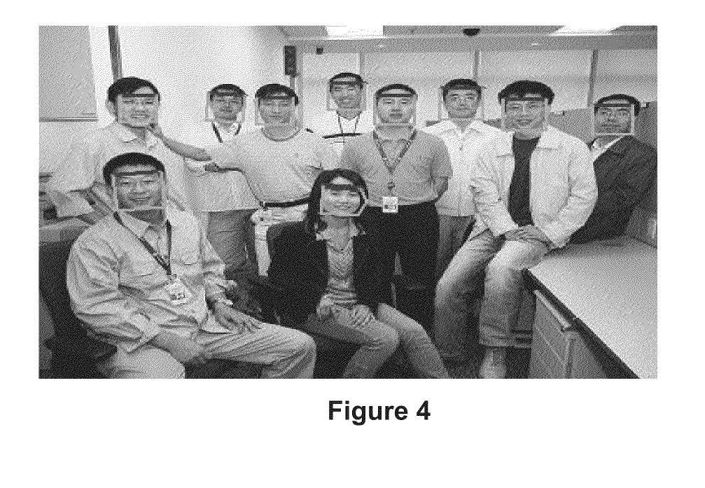

FIGS. 3 and 4 are example images of face detection according to an embodiment of the present invention.

Returning to FIG. 2, as a user changes his or her poses in front of the camera over time, 2D landmark points detection processing may be performed at block 204 to estimate the transformations and align correspondence for each face in a sequence of 2D images. In an embodiment, this processing may be performed by 2D landmark points detection component 108. After locating the face regions during face detection processing 202, embodiments of the present invention detect accurate positions of facial features such as the mouth, corners of the eyes, and so on. A landmark is a point of interest within a face. The left eye, right eye, and nose base are all examples of landmarks. The landmark detection process affects the overall system performance for face related applications, since its accuracy significantly affects the performance of successive processing, e.g., face alignment, face recognition, and avatar animation. Two classical methods for facial landmark detection processing are the Active Shape Model (ASM) and the Active Appearance Model (AAM). The ASM and AAM use statistical models trained from labeled data to capture the variance of shape and texture. The ASM is disclosed in “Statistical Models of Appearance for Computer Vision,” by T. F. Cootes and C. F. Taylor, Imaging Science and Biomedical Engineering, University of Manchester, Mar. 8, 2004.

According to face geometry, in an embodiment, six facial landmark points may be defined and learned for eye corners and mouth corners. An Active Shape Model (ASM)-type of model outputs six degree-of-freedom parameters: x-offset x, y-offset v, rotation r, inter-ocula distance o, eye-to-mouth distance e, and mouth width m. Landmark detection processing 204 produces one or more sets of these 2D landmark points ([x, y, r, o, e, m]).

In an embodiment, 2D landmark points detection processing 204 employs robust boosted classifiers to capture various changes of local texture, and the 3D head model may be simplified to only seven points (four eye corners, two mouth corners, one nose tip). While this simplification greatly reduces computational loads, these seven landmark points along with head pose estimation are generally sufficient for performing common face processing tasks, such as face alignment and face recognition. In addition, to prevent the optimal shape search from falling into a local minimum, multiple configurations may be used to initialize shape parameters.

In an embodiment, the cascade classifier may be run at a region of interest in the face image to generate possibility response images for each landmark. The probability output of the cascade classifier at location (x, y) is approximated as:

$$P ( x , y ) = 1 - {\prod }_{i = 1}^{k ( x , y )} {f}_{i} ,$$

where ƒᵢ is the false positive rate of the i-th stage classifier specified during a training process (a typical value of ƒᵢ is 0.5), and k(x, y) indicates how many stage classifiers were successfully passed at the current location. It can be seen that the larger the score is, the higher the probability that the current pixel belongs to the target landmark.

In an embodiment, seven facial landmark points for eyes, mouth and nose may be used, and may be modeled by seven parameters: three rotation parameters, two translation parameters, one scale parameter, and one mouth width parameter.

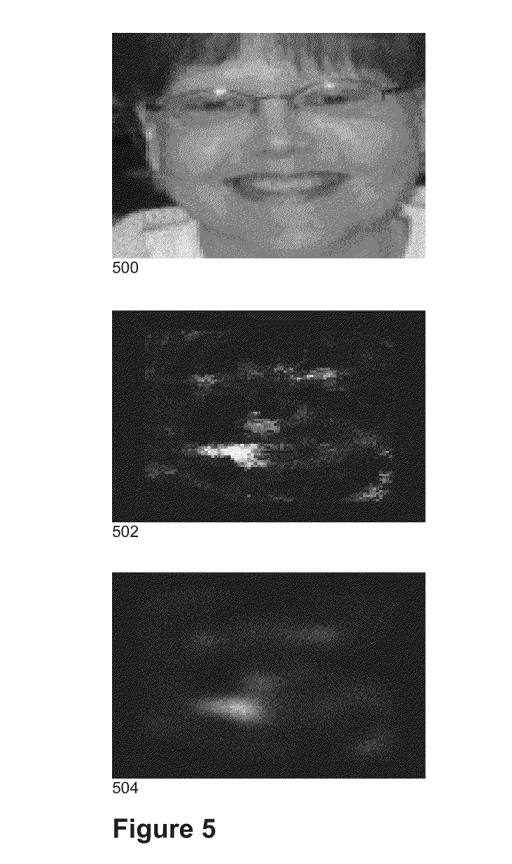

FIG. 5 is an example of the possibility response image and its smoothed result when applying a cascade classifier to the left corner of the mouth on a face image 500. When a cascade classifier of the left corner of mouth is applied to the region of interest within a face image, the possibility response image 502 and its Gaussian smoothed result image 504 are shown. It can be seen that the region around the left corner of mouth gets much higher response than other regions.

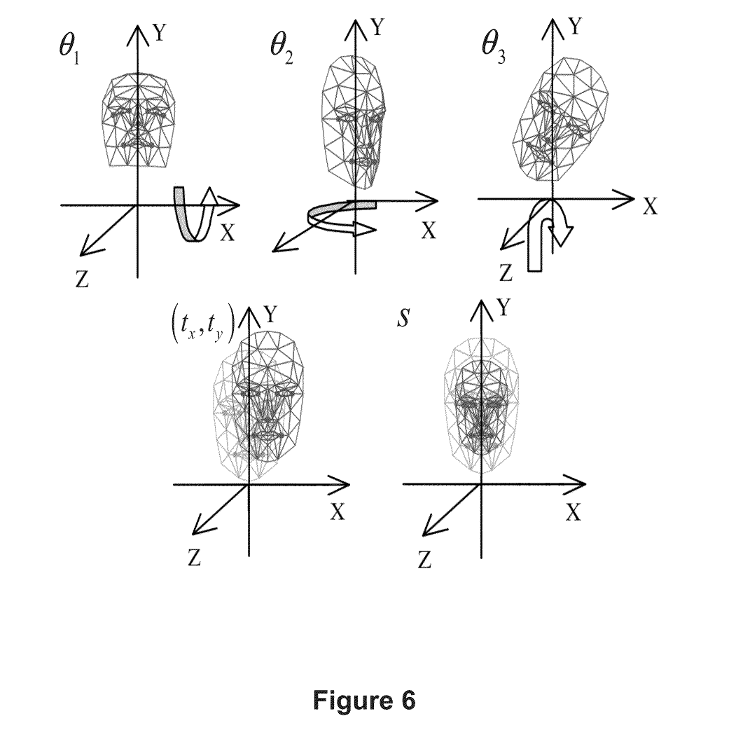

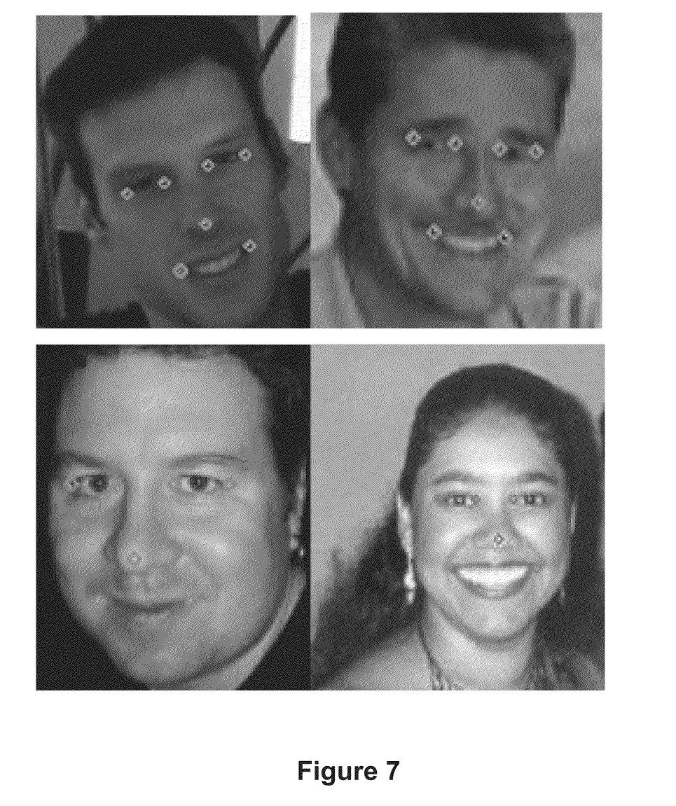

In an embodiment, a 3D model may be used to describe the geometry relationship between the seven facial landmark points. While parallel-projected onto a 2D plane, the position of landmark points are subjected to a set of parameters including 3D rotation (pitch θ₁, yaw θ₂, roll θ₃), 2D translation (tₓ, t_{y}) and scaling (s), as shown in FIG. 6. However, these 6 parameters (θ₁, θ₂, θ₃, t_{y}, s) describe a rigid transformation of a base head shape but do not consider the shape variation due to subject identity or facial expressions. To deal with the shape variation, one additional parameter λ may be introduced, i.e., the ratio of mouth width over the distance between the two eyes. In this way, these seven shape control parameters S=(θ₁, θ₂, θ₃, tₓ, t_{y}, s, λ) are able to describe a wide range of face variation in images, as shown in the example set of images of FIG. 7.

The cost of each landmark point is defined as:

Eᵢ=1−P(x, y),

where P(x, y) is the possibility response of the landmark at the location (x, y), introduced in the cascade classifier.

The cost function of an optimal shape search takes the form:

cost(S)=ΣEᵢ+regulation(λ),

where S represents the shape control parameters.

When the seven points on the 3D head model are projected onto the 2D plane according to a certain S, the cost of each projection point Eᵢ may be derived and the whole cost function may be computed. By minimizing this cost function, the optimal position of landmark points in the face region may be found.

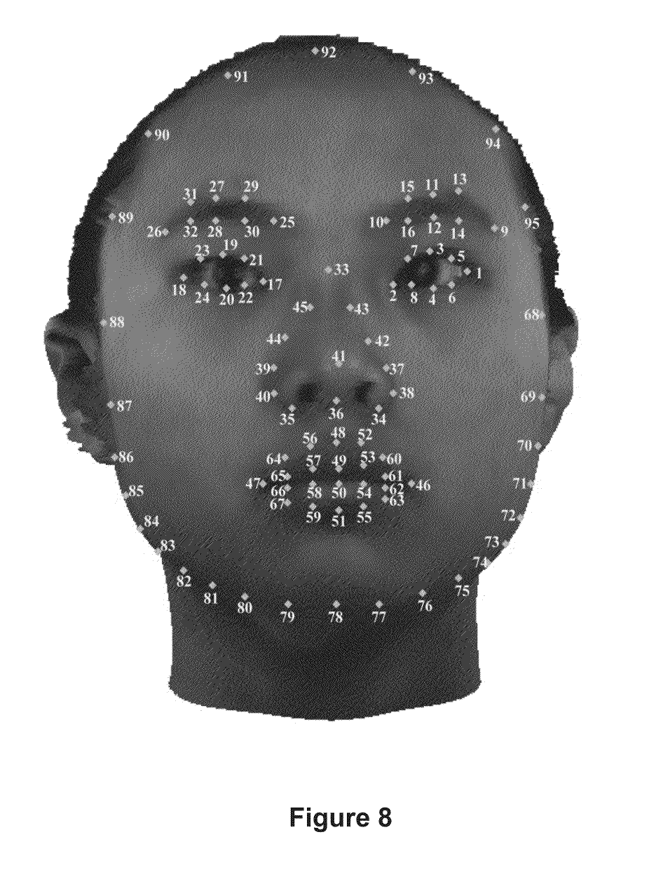

In an embodiment of the present invention, up to 95 landmark points may be determined, as shown in the example image of FIG. 8.

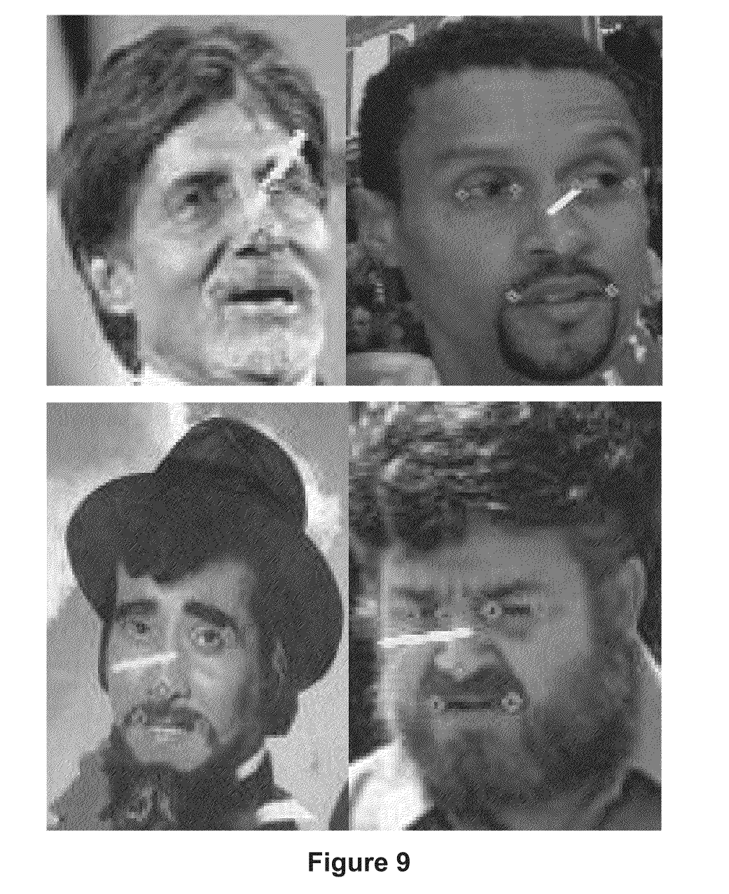

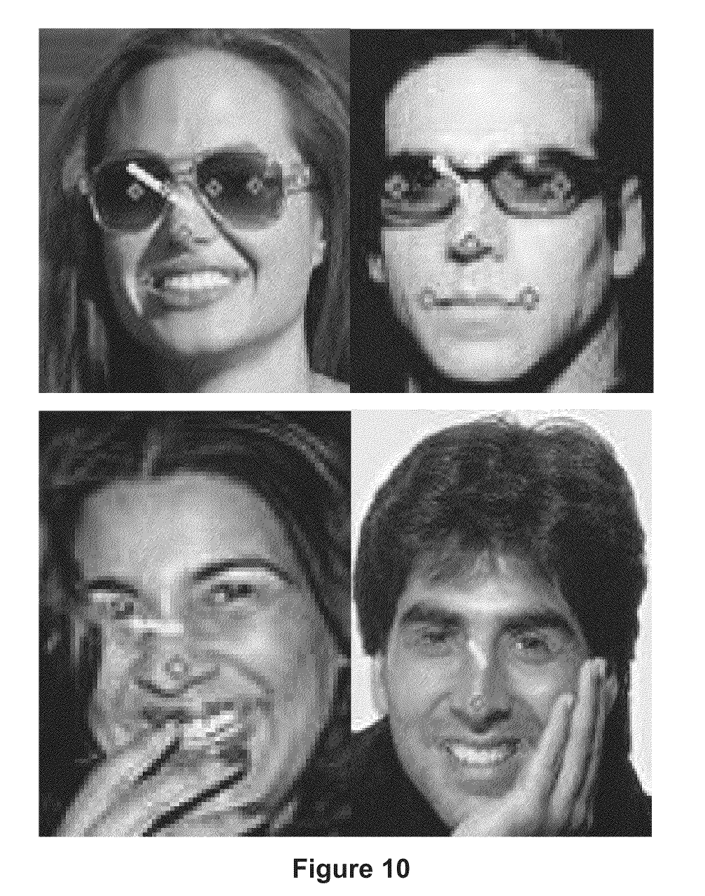

FIGS. 9 and 10 are examples of facial landmark points detection processing performed on various face images. FIG. 9 shows faces with moustaches. FIG. 10 shows faces wearing sunglasses and faces being occluded by a hand or hair. Each white line indicates the orientation of the head in each image as determined by 2D landmark points detection processing 204.

Returning back to FIG. 2, in order to generate a personalized avatar representing the user's face, in an embodiment, the 2D landmark points determined by 2D landmark points detection processing at block 204 may be registered to the 3D generic face model 104 by 3D landmark points registration processing at block 206. In an embodiment, 3D landmark points registration processing may be performed by 3D landmark points registration component 110. The model-based approaches may avoid drift by finding a small re-projection error rₑ of landmark points of a given 3D model into the 2D face image. As least-squares minimization of an error function may be used, local minima may lead to spurious results. Tracking a number of points in online key flames may solve the above drawback. A rough estimation of external camera parameters like relative rotation/translation P=[R|t] may be achieved using a five point method if the 2D to 2D correspondence xᵢxᵢ′ is known, where xᵢ is the 2D projection point in one camera plane, xᵢ′ is the corresponding 2D projection point in the other camera plane. In an embodiment, the re-projection error of landmark points may be calculated as rₑ=I=1 kp(mi−PMᵢ), where rₑ represents the re-projection error, p represents a Tukey M-estimator, PMᵢ represents the projection of the 3D point Mᵢ given the pose P. 3D landmark points registration processing 206 produces one or more re-projection errors rₑ.

In further detail, in an embodiment, 3D landmark points registration processing 206 may be performed as follows. Having defined a reference scan or mesh with p vertices, the coordinates of these ρ corresponding surface points are concatenated to a vector vᵢ=(x₁, y₁, z₁, . . . , xₚ, yₚ, zₚ)^{T}εRⁿ; n=3p. In this representation, any convex combination:

$$\text{?} = {\sum }_{\text{?}}^{\text{?}} \text{?} ∈ {\sum }_{\text{?}}^{\text{?}} \text{?} = \text{?}$$

$$\text{?} \text{indicates text missing or illegible when filed}$$

describes a new element of the class. In order to remove the second constraint, barycentric coordinates may be used relative to the arithmetic mean:

$$x = v - \overline{v} , \overline{v} = \frac{1}{m} {\sum }_{i = 1}^{m} \text{?} , \\ SO$$

$$\text{?} \text{?} \text{indicates text missing or illegible when filed}$$

The class may be described in terms of a probability density p(v) of v being in the object class. p(v) can be estimated by a Principal Component Analysis (PCA): Let the data matrix X be

X=(x₁, x₂, . . . , x [symbol] ) ε

[symbol]

The covariance matrix of the data set is given by

$$C = \frac{1}{m} {XX}^{T} = \frac{1}{m} {\sum }_{j = 1}^{m} {x}_{j} {x}_{j}^{T} \text{?} ∈ \text{?}$$

$$\text{?} \text{indicates text missing or illegible when filed}$$

PCA is based on a diagonalization

C=S˜diag(σ [symbol] ²)·S^{T},

Since C is symmetrical, the columns sᵢ of S form an orthogonal set of eigenvectors. σᵢ are the standard deviations within the data along the eigenvectors. The diagonalization can be calculated by a Singular Value Decomposition (SVD) of X,

If the scaled eigenvectors σᵢsᵢ are used as a basis, vectors x are defined by coefficients cᵢ:

$$x = {\sum }_{\text{?}}^{\text{?}} \text{?} {σ}_{i} {s}_{i} = S \cdot diag ( {σ}_{i} ) \text{?}$$

$$\text{?} \text{indicates text missing or illegible when filed}$$

Given the positions of a reduced number f<p of feature points, the task is to find the 3D coordinates of all other vertices. The 2D or 3D coordinates of the feature points may be written as vectors rεR¹(1=2f, or 1=3f), and assume that r is related to y by

r=Lv L:

[symbol]

[symbol]

[symbol]

[symbol]

L may be any linear mapping, such as a product of a projection that selects a subset of components from v for sparse feature points or remaining surface regions, a rigid transformation in 3D, and an orthographic projection to image coordinates. Let

y=r−L v̅=Lx,

if L is not one-to-one, the solution x will not be uniquely defined. To reduce the number of free parameters, x may be restricted to the linear combinations of x_{i.}

Next, minimize

E(x)=∥Lx−y∥².

Let

qᵢ=L(σᵢsᵢ)ε

[symbol]

[symbol]

be the reduced versions of the scaled eigenvectors, and

[symbol]

=(q₁, q₂, . . . )=LS·diag(σᵢ)ε

[symbol]

[symbol]

In terms of model coefficients cᵢ

$$E ( c ) = {‖ L {\sum }_{\text{?}}^{ } \text{?} {s}_{\text{?}} - y ‖}^{\text{?}} = {‖ Qc - y ‖}^{2} . \\ \text{?} \text{indicates text missing or illegible when filed}$$

The optimum can be found by a Singular Value Decomposition Q=UWV^{T} with a diagonal matrix w=diag(wₓ), and v^{T}v=vv^{T}=id [symbol] . The pseudo-inverse of Q

$${Q}^{+} = {VW}^{+} {U}^{T} , \\ {W}^{+} = diag ( \begin{matrix}\text{?} & if \text{?} \\ 0 & otherwise\end{matrix} ) . \\ \text{?} \text{indicates text missing or illegible when filed}$$

To avoid numerical problems, the condition wᵢ≠0 may be replaced by a threshold wᵢ>ε. The minimum of E(c) can be computed with the pseudo-inverse: c=Q⁺y.

This vector c has another important property: If the minimum of E(c) is not uniquely defined, c is the vector with minimum norm [symbol] among all c′ with E(c′)=E(c). This means that the vector may be obtained with maximum prior probability. c is mapped to Rⁿ,

v=S·diag(σᵢ)c [symbol] v̅.

It may be more straightforward to compute x=L⁺y with the pseudo-inverse L⁺ of L.

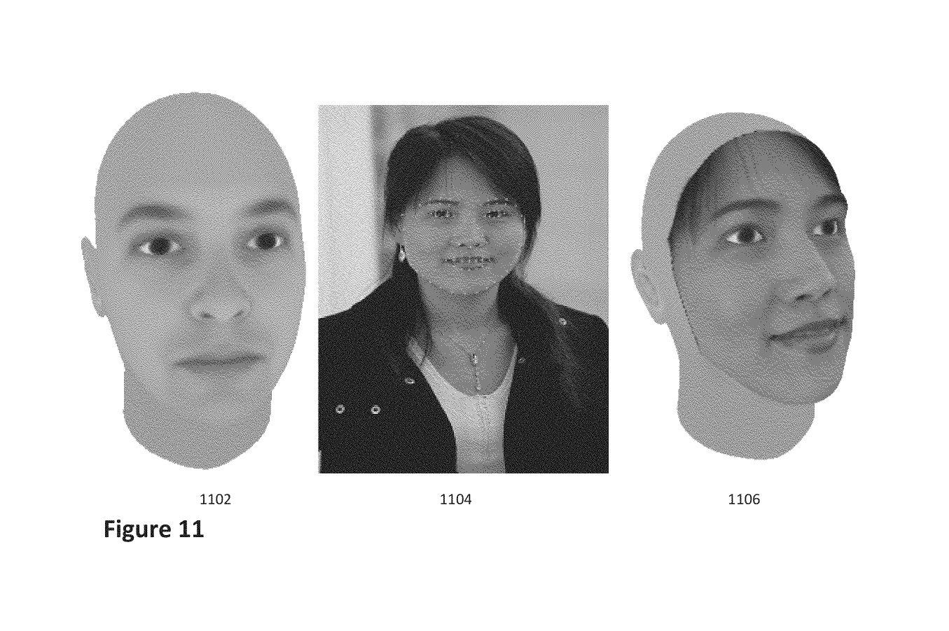

FIG. 11 shows example images of landmark points registration processing 206 according to an embodiment of the present invention. An input face image 1104 may be processed and then applied to generic 3D face model 1102 to generate at least a portion of personalized avatar parameters 208 as shown in personalized 3D model 1106.

In an embodiment, the following processing may be performed for the 3D data domain. Referring back to FIG. 2, for the process of reconstructing the 3D face model, stereo matching for an eligible image pair may be performed at block 210. This may be useful for stability and accuracy. In an embodiment, stereo matching may be performed by personalized avatar generation component 112. Given calibrated camera parameters, the image pairs may be rectified such that an epipolar-line corresponds to a scan-line. In experiments, DAISY features (as discussed below) perform better than the Normalized Cross Correlation (NCC) method and may be extracted in parallel. Given every two image pairs, point correspondences may be extracted as xixi′. The camera geometry for each image pair may be characterized by a Fundamental matrix F, Homography matrix H. In an embodiment, a camera pose estimation method may use a Direct Linear Transformation (DLT) method or an indirect five point method. The stereo matching processing 210 produces camera geometry parameters {xᵢ<->xᵢ′} {xₖᵢ, PₖᵢXᵢ}, where xᵢ is a 2D reprojection point in one camera image, xᵢ′ is the 2D reprojection point in the other camera image, xₖᵢ is the 2D reprojection point of camera k, point j, and Pₖᵢ is the projection matrix of camera k, point j, Xᵢ is the 3D point in physical world.

Further details of camera recovery and stereo matching are as follows. Given a set of images or video sequences, the stereo matching processing aims to recover a camera pose for each image/frame. This is known as the structure-from-motion (SFM) problem in computer vision. Automatic SFM depends on stable feature points matches across image pairs. First, stable feature points must be extracted for each image. In an embodiment, the interest points may comprise scale-invariant feature transformations (SIFT) points, speeded up robust features (SURF) points, and/or Harris corners. Some approaches also use line segments or curves. For video sequences, tracking points may also be used.

Scale-invariant feature transform (or SIFT) is an algorithm in computer vision to detect and describe local features in images. The algorithm was described in “Object Recognition from Local Scale-Invariant Features,” David Lowe, Proceedings of the International Conference on Computer Vision 2, pp. 1150-1157, September, 1999. Applications include object recognition, robotic mapping and navigation, image stitching, 3D modeling, gesture recognition, video tracking, and match moving. It uses an integer approximation to the determinant of a Hessian blob detector, which can be computed extremely fast with an integral image (3 integer operations). For features, it uses the sum of the Haar wavelet response around the point of interest. These may be computed with the aid of the integral image.

SURF (Speeded Up Robust Features) is a robust image detector & descriptor, disclosed in “SURF, Speeded Up Robust Features,” Herbert Bay, Andreas Ess, Tinne Tuytelaars, and Luc Van Gool, Computer Vision and Image Understanding (CVIU), Vol. 110, No. 3, pp. 346-358, 2008, that can be used in computer vision tasks like object recognition or 3D reconstruction. It is partly inspired by the SIFT descriptor. The standard version of SURF is several times faster than SIFT and claimed by its authors to be more robust against different image transformations than SIFT. SURF is based on sums of approximated 2D Haar wavelet responses and makes an efficient use of integral images.

Regarding Harris corners, in the fields of computer vision and image analysis, the Harris-affine region detector belongs to the category of feature detection. Feature detection is a preprocessing step of several algorithms that rely on identifying characteristic points or interest points so as to make correspondences between images, recognize textures, categorize objects or build panoramas.

Given two images I and J, suppose the SIFT point sets are and K_{I}={kᵢ₁, . . . , kᵢₙ} and K_{J}={kⱼ₁, . . . , kⱼₘ}. For each query keypoint kᵢ in K_{I}, matched points may be found in K_{J}. In one embodiment, the nearest neighbor rule in SIFT feature space may be used. That is, the keypoint with the minimum distance to the query point kᵢ is chosen as the matched point. Suppose d₁₁ is the nearest neighbor distance from kᵢ to K_{J} and d₁₂ is distance from kᵢ to the second-closed neighbor in K_{J}. The ratio r=d₁₁/d₁₂ is called the distinctive ratio. In an embodiment, when r>0.8, the match may be discarded due to it having a high probability of being a false match.

The distinctive ratio gives initial matches; suppose point pᵢ=(xᵢ, yᵢ) is matched to point pⱼ=(xⱼ, yⱼ), the disparity direction may be defined as \vec{pᵢpⱼ}. As a refined step, outliers may be removed with a median-rejection filter. If there are enough keypoints ≧8 in a local neighborhood of pⱼ, and a disparity direction close-related to \vec{pᵢpⱼ} cannot be found in that neighborhood, pⱼ is rejected.

There are some basic relationships that exist between two and more views. Suppose each view has an associated camera matrix P, and a 3D space point X is imaged as x=PX in the first view, and x′=P′X in the second view. There are three problems which the geometry relationship can help answer: (1) Correspondence geometry: Given an image point x in the first view, how does this constrain the position of the corresponding point x′ in the second view? (2) Camera geometry: Given a set of corresponding image points {xᵢ [symbol] xᵢ′}, i=1, . . . , n, what are the camera matrices P and P′ for the two views? (3) Scene geometry: Given corresponding image points xᵢ [symbol] xᵢ′ and camera matrices P, P′, what is the position of X in 3D space?

Generally, these matrices are useful correspondence geometry: the fundamental matrix F and the nomography matrix H. The fundamental matrix is a relationship between any two images of the same scene that constrains where the projection of points from the scene can occur in both images. The fundamental matrix is described in “The Fundamental Matrix: Theory, Algorithms, and Stability Analysis,” Quan-Tuan Lunn and Olivier D. Faugeras, International Journal of Computer Vision, Vol. 17, No. 1, pp. 43-75, 1996. Given the projection of a scene point into one of the images the corresponding point in the other image is constrained to a line, helping the search, and allowing for the detection of wrong correspondences. The relation between corresponding image points which the fundamental matrix represents is referred to as epipolar constraint, matching constraint, discrete matching constraint, or incidence relation. In computer vision, the fundamental matrix F is a 3×3 matrix which relates corresponding points in stereo images. In epipolar geometry, with homogeneous image coordinates, x and x′, of corresponding points in a stereo image pair, Fx describes a line (an epipolar line) on which the corresponding point x′ on the other image must lie. That means, for all pairs of corresponding points holds

x′^{T}Fx=0

Being of rank two and determined only up to scale, the fundamental matrix can be estimated given at least seven point correspondences. Its seven parameters represent the only geometric information about cameras that can be obtained through point correspondences alone.

Homography is a concept in the mathematical science of geometry. A homography is an invertible transformation from the real projective plane to the projective plane that maps straight lines to straight lines. In the field of computer vision, any two images of the same planar surface in space are related by a homography (assuming a pinhole camera model). This has many practical applications, such as image rectification, image registration, or computation of camera motion—rotation and translation—between two images. Once camera rotation and translation have been extracted from an estimated homography matrix, this information may be used for navigation, or to insert models of 3D objects into an image or video, so that they are rendered with the correct perspective and appear to have been part of the original scene.

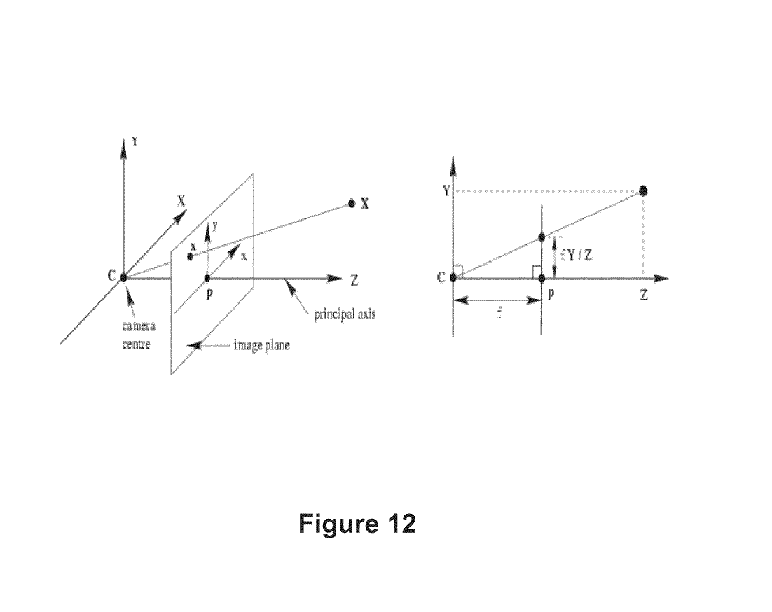

FIG. 12 is an illustration of a camera model according to an embodiment of the present invention.

The projection of a scene point may be obtained as the intersection of a line passing through this point and the center of projection C and the image plane. Given a world point (X, Y, Z) and the corresponding image point (x, y), then (X, Y, Z)→(x, y)=(fX/Z, fY/Z). Further, consider the imaging center, we have the following matrix form of camera model:

$$( \begin{matrix}\text{?} \\ \text{?} \\ \text{?}\end{matrix} ) \text{?} ( \text{?} . \\ \text{?} \text{indicates text missing or illegible when filed}$$

The first righthand matrix is named the camera intrinsic matrix K in which pₓ and p_{y} define the optical center and f is the focal-length reflecting the stretch-scale from the image to the scene. The second matrix is the projection matrix |R t|. The camera projection may be written as x=K|R t|X or x=PX, where P=K|R t| (a 3×4 matrix). In embodiments of the present invention, camera pose estimation approaches include the direct linear transformation (DLT) method, and the five point method.

Direct linear transformation (DLT) is an algorithm which solves a set of variables from a set of similarity relations:

xₖ∝Ayₖ

for

k=1, . . . , N

where xₖ and yₖ are known vectors, ∝ denotes equality up to an unknown scalar multiplication, and A is a matrix (or linear transformation) which contains the unknowns to be solved.

Given image measurement x=PX and x′=P′X, the scene geometry aims to computing the position of a point in 3D space. The naive method is triangulation of back-projecting rays from two points x and x′. Since there are errors in the measured points x and x′, the rays will not intersect in general. It is thus necessary to estimate a best solution for the point in 3D space which requires the definition and minimization of a suitable cost function.

Given 4-point correspondences and their projection matrix, the naive triangulation can be solved by applying the direct linear transformation (DLT) algorithm as x(PX)=0. In practice, the geometric error may be minimized to obtain optimal position:

C(x, x′)=d²(x, \hat{x})+d²(x′, \hat{x}′),

where x̂=PX̂ is the re-projection of X̂.

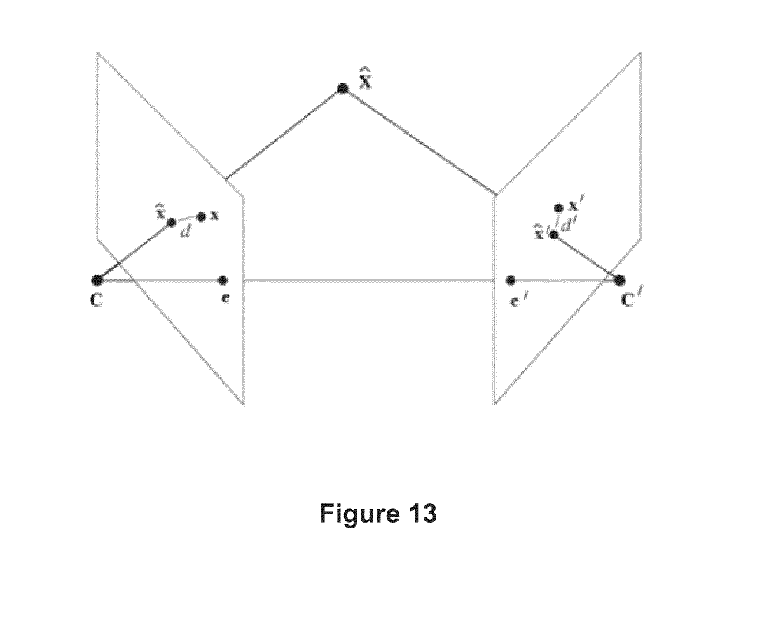

FIG. 13 illustrates a geometric re-projection error rₑ according to an embodiment of the present invention.

Referring back to FIG. 2, dense matching and bundle optimization may be performed at block 212. In an embodiment, dense matching and bundle optimization may be performed by personalized avatar generation component 112. When there are a series of images, a set of corresponding points in the multiple images may be tracked as tₖ={x1ₖ, x2ₖ, x3ₖ, . . . } which depict the same 3D point in the first image, second image, and third image, and so on. For the whole image set (e.g., sequence of video frames), the camera parameters and 3D points may be refined through a global minimization step. In an embodiment, this minimization is called bundle adjustment and the criterion is

$${min}_{\text{?}} {\sum }_{\text{?}}^{\text{?}} {\sum }_{\text{?}}^{\text{?}} \text{?} ( \text{?} ) . \\ \text{?} \text{indicates text missing or illegible when filed}$$

In an embodiment, the minimization may be reorganized according to camera views, yielding a much small optimization problem. Dense matching and bundle optimization processing 212 produces one or more tracks/positions w(xᵢ^{k}) Hᵢⱼ.

Further details of dense matching and bundle optimization are as follows. For each eligible stereo pair of images, during stereo matching 210 the image views are first rectified such that an epipolar line corresponds to a scan-line in the images. Suppose the right image is the reference view, for each pixel in the left image, stereo matching finds the closed matching pixel on the corresponding epipolar line in the right image. In an embodiment, the matching is based on DAISY features, which is shown superior to the normalized cross correlation (NCC) based method in dense stereo matching. DAISY is disclosed in “DAISY: An Efficient Dense Descriptor Applied to Wide-Baseline Stereo,” Engin Tola, Vincent Lepetit, and Pascal Fua, IEEE Transactions on Pattern Analysis and Machine Intelligence, Vol. 32, No. 5, pp. 815-830, May, 2010.

In at embodiment, a kd-tree may be adopted to accelerate the epipolar line search. First, DAISY features may be extracted for each pixel on the scan-line of the right image, and these features may be indexed using the kd-tree. For each pixel on the corresponding line of the left image, the top-K candidates may be returned in the right image by the kd-tree search, with K=10 in one embodiment. After the whole scan-line is processed, intra-line results may be further optimized by dynamic programming within the top-K candidates. This scan-line optimization guarantees no duplicated correspondences within a scan-line.

In an embodiment, the DAISY feature extraction processing on the scan-lines may be performed in parallel. In this embodiment, the computational complexity is greatly reduced from the NCC based method. Suppose the epipolar-line contains n pixels, the complexity of NCC based matching is O(n²) in one scan-line, while the complexity of embodiments of the present invention case is O(2n log n). This is because the kd-tree building complexity is O(n log n), and the kd-tree search complexity is O(log n) per query.

For the consideration of running speed on high resolution images, a sampling step s=(1, 2, . . . ) or the scan-line of left image may be defined, keep searching continues for every pixel in the corresponding line of reference image. For instance, s=2 means that only correspondences may be found for every two pixels in the scan-line of left image. When depth-maps are ready, unreliable matches may be filtered. In detail, first, matches may be filtered wherein the angle between viewing rays falls outside the range 5°-45°, Second, matches may be filtered wherein the cross-correlation of DAISY features is less than a certain threshold, such as α=0.8, in one embodiment. Third, if optional object silhouettes are available, the object silhouettes may be used to further filter unnecessary matches.

Bundle optimization at block 212 has two main stages: track optimization and position refinement. First, a mathematical definition of a track is shown. Given n images, suppose x₁^{k} is a pixel in the first image, it matches to pixel x₂^{k} in the second image, and further x₂^{k} matches to x₃^{k} in the third image, and so on. The set of matches [tₖ=[x]₁^{k}, x₂^{k}, x₃^{k}, . . . ] is called a track, which should correspond to the same 3D point. In embodiments of the present invention, each track must contain pixels coming from at least β views (where β=3 in an embodiment). This constraint can ensure the reliability of tracks.

All possible tracks may be collected in the following way. Starting from 0-th image, given a pixel in this image, connected matched pixels may be recursively traversed in all of the other n−1 images. During this process, every pixel may be marked with a flag when it has been collected by a track. This flag can avoid redundant traverses. All pixels may be looped over the 0-th image in parallel. When this processing is finished with the 0-th image, the recursive traversing process may be repeated on unmarked pixels in left images.

When tracks are built, each of them may be optimized to get an initial 3D point cloud. Since some tracks may contain erroneous matches, direct triangulation will introduce outliers. In an embodiment, views which have a projection error surpassing a threshold y may be penalized (γ=2 pixels in an embodiment), and the objective function for the k-th track tₖ may be defined as follows:

$$min {\sum }_{\text{?}}^{ } \text{?} ( {x}_{\text{?}}^{k} ) ‖ {x}_{\text{?}}^{k} - {P}_{i}^{k} {\hat{X}}^{k} ‖ \text{?}$$

$$\text{?} \text{indicates text missing or illegible when filed}$$

where xᵢ^{k} is a pixel from i-th view, p₁^{k} is the projection matrix of i-th view, \tilde{X}ᵢ^{k} is the estimated 3D point of the track, and w(xᵢ^{k}) is a penalty weight defined as follows:

$$w ( {x}_{\text{?}}^{\text{?}} ) = \{ \begin{matrix}1 & if ‖ {x}_{\text{?}}^{k} - {P}_{\text{?}}^{k} \hat{X} \text{?} ‖ < 7 \text{?} \\ 10 & otherwise .\end{matrix} \\ \text{?} \text{indicates text missing or illegible when filed}$$

In an embodiment, the objective may be minimized with the well known Levenberg-Marquardt algorithm. When the optimization is finished, each track may be checked for the number eligible view, i.e., #(w(xᵢ^{k})==1). A track tₖ is reliable if #(w(xki)==1)≦β. Initial 3D point clouds may then be created from reliable tracks.

Although the initial 3D point cloud is reliable, there are two problems. First, the point positions are still not quite accurate since stereo matching does not have sub-pixel level precision. Additionally, the point cloud does not have normals. The second stage focuses on the problem of point position refinement and normal estimation.

Given a 3D point X and projection matrix of two views P₁=K₁[I,0] and P₂=K₂[R, t], the point X and its normal n form a plane π:n^{T}X+d=0, where d can be interpreted as the distance from the optical center of camera-1 to the plane. This plane is known as the tangent plane of the surface at point X. One property is that this plane induces a homography:

H=K₂(R−tn^{T}/d)Kₗ⁻¹

As a result, distortion from matching of the rectangle window can be eliminated via a homography mapping. Given 3D points and corresponding reliable track of views, total photo-consistence of the track may be computed based on homography mapping as

$${E}_{k} = {\sum }_{\text{?}}^{ } ‖ {DF}_{i} ( x ) - {DF}_{j} ( {H}_{ij} ( \text{?} , d ) ) ‖ \text{?}$$

$$\text{?} \text{indicates text missing or illegible when filed}$$

where DFᵢ(x) means the DAISY feature at pixel x in view-i, and Hᵢⱼ(x;n,d) is the homography from view-I to view-j with parameters n and d.

Minimization Eₖ yields the refinement of point position and accurate estimation of point normals. In practice, the minimization is constrained by two items: (1) the re-projection point should be in a bounding box of original pixel; (2) the angle between normal n and the view ray \vec{XOᵢ} (Oᵢ s the center camera-i) should be less than 60° to avoid shear effect. Therefore, the objective defined as

$$min E \text{?}$$

$$s . t . \\ ( 1 ) \vert \text{?} - \text{?} \vert < \text{?}$$

$$( 2 ) \text{?} * \vec{{X}_{\text{?}}^{i} \text{?}} ‖ \vec{{X}_{\text{?}}^{i} {O}_{i}} ‖ > 0.5 , \\ \text{?} \text{indicates text missing or illegible when filed}$$

where [symbol] is the re-projection point of pixel xᵢ.

Returning back to FIG. 2, after completing the processing steps of blocks 210 and 212, a point cloud may be reconstructed in denoising/orientation propagation processing at block 214. In an embodiment, denoising/orientation propagation processing may be performed by personalized avatar generation component 112. However, to generate a smooth surface from the point cloud, denoising 214 is needed to reduce ghost geometry off-surface points. Ghost geometry off-surface points are artifacts in the surface reconstruction results where the same objects appear repeatedly. Normally, local mini-ball filtering and non-local bilateral filtering may be applied. To differentiate between an inside surface and an outside surface, the point's normal may be estimated. In an embodiment, a plane-fitting based method, orientation from cameras, and tangent plane orientation may be used. Once an optimized 3D point cloud is available, in an embodiment, a watertight mesh may be generated using an implicit fitting function such as Radial Basis Function, Poisson Equation, Graphcut, etc. Denoising/orientation processing 214 produces a point cloud/mesh {p, n, f}.

Further details of denoising/orientation propagation processing 214 are as follows. To generate a smooth surface from the point cloud, geometric processing is required since the point cloud may contain noises or outliers, and the generated mesh may not be smooth. The noise may come from several aspects: (1) Physical limitations of the sensor lead to noise in the acquired data set such as quantization limitations and object motion artifacts (especially for live objects such as a human or an animal). (2) Multiple reflections can produce off-surface points (outliers). (3) Undersampling of the surface may occurs due to occlusion, critical reflectance, and constraints in the scanning path or limitation of sensor resolution. (4) The triangulating algorithm may produce a ghost geometry for redundant scanning/photo-taking at rich texture region. Embodiments of the present invention provide at least two kinds of point cloud denoising modules.

The first kind of point cloud denoising module is called local mini-ball filtering. A point comparatively distant to the cluster built by its k nearest neighbors is likely to be an outlier. This observation leads to the mini-ball filtering. For each point p consider the smallest enclosing sphere S around nearest neighbor of p (i.e., Nₚ). S can be seen as an approximation of the k-nearest-neighbor cluster. Comparing p's distance d to the center of S with the sphere's diameter yields a measure for p's likelihood to be an outlier. Consequently, the mini-ball criterion may be defined as

$$x ( p ) = \frac{d }{d + 2 \text{?} / \sqrt{k}} . \\ \text{?} \text{indicates text missing or illegible when filed}$$

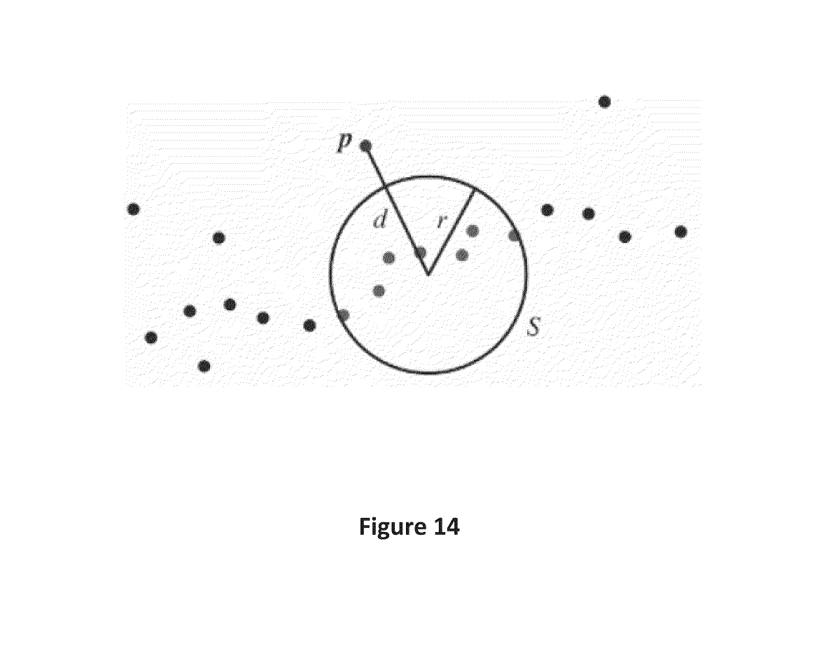

Normalization by k compensates for the diameter's increase with increasing number of k-neighbors (usually k≧10) at the object surface. FIG. 14 illustrates the concept of mini-ball filtering.

In an embodiment, the mini-ball filtering is done in the following way. First, compute χ(pᵢ) for each point pᵢ, and further compute the mean μ and variance σ of {χ(pᵢ)}. Next, filter out any point pᵢ whose χ(pᵢ)>3σ. In an embodiment, implementation of a fast k-nearest neighbor search may be used. In an embodiment, in point cloud processing, an octree or a specialized linear-search tree may be used instead of a kd-tree, since in some cases a kd-tree works poorly (both inefficiently and inaccurately) when returning k≧10 results. At least one embodiment of the present invention adopts the specialized linear-search tree, GLtree, for this processing.

The second kind of point cloud denoising module is called non-local bilateral filtering. A local filter can remove outliers, which are samples located far away from the surface. Another type of noise is the high frequency noise, which are ghost or noise points very near to the surface. The high frequency noise is removed using non-local bilateral filtering. Given a pixel p and its neighborhood N(p), it is defined as

$$\text{?} ( p ) = \frac{{\sum }_{\text{?} = ∈ N ( p )}^{ } {W}_{c} ( p , u ) {W}_{s} ( p , u ) I ( p )}{{\sum }_{u ∈ N ( p )}^{ } {W}_{c} ( p , u ) {W}_{s} ( p , u )}$$

$$\text{?} \text{indicates text missing or illegible when filed}$$

where W_{c}(p,u) measures the closeness between p and u, and Wₛ(p,u) measures the non-local similarity between p and u. In our point cloud processing, W_{c}(p,u) is defined as the distance between vertex p and u, while Wₛ(p,u) is defined as the Haussdorff distance between N(p) and N(u).

In an embodiment, point cloud normal estimation may be performed. The most widely known normal estimation algorithm is disclosed in “Surface Reconstruction from Unorganized Points,” by H. Hoppe, T. DeRose, T. Duchamp, S. McDonald, and W. Stuetzle, Computer Graphics (SIGGRAPH), Vo. 26, pp. 19-26, 1992. The method first estimates a tangent plane from a collection of neighborhood points of p utilizes covariance analysis, the normal vector is associated with the local tangent plane.

$$C = {\sum }_{\text{?}}^{\text{?}} {( {P}_{\text{?}} - \text{?} )}^{T} ( {p}_{\text{?}} - \text{?} ) , \\ where$$

$$\text{?} = \frac{1}{k} {\sum }_{\text{?}}^{k} {p}_{\text{?}}$$

$$\text{?} \text{indicates text missing or illegible when filed}$$

The normal is given as uᵢ, the eigen vector associated with the smallest eigenvalue of the covariance matrix C. Notice that the normals computed by fitting planes are unoriented. An algorithm is required to orient the normals consistently. In case that the acquisition process is known, i.e., the direction cᵢ from surface point to the camera is known. The normal may be oriented as below

$$\text{?} = \{ \begin{matrix}{u}_{i} & if {u}_{i} \cdot \text{?} > 0 \\ - {u}_{i} & else\end{matrix} \\ \text{?} \text{indicates text missing or illegible when filed}$$

Note that nᵢ is only an estimate, with a smoothness controlled by neighborhood size k. The direction cᵢ may be also wrong at some complex surface.

Returning back to FIG. 2, with the reconstructed point cloud, normal and mesh {p, n, m}, seamless texture mapping/image blending 216 may be performed to generate a photo-realistic browsing effect. In an embodiment, texture mapping/image blending processing may be performed by personalized avatar generation component 112. In an embodiment, there are two stages: a Markov Random Field (MRF) to optimize a texture mosaic, and a local radiometer correction for color adjustment. The energy function of MRF framework may be composed of two terms: the quality of visual details and the color continuity. The main purpose of color correction is to calculate a transformation matrix between fragments Vi=TijVj, where V depicts the average brightness of fragment i and Tij represents the transformation matrix. Texture mapping/image blending processing 216 produces patch/color Vi, Ti->j.

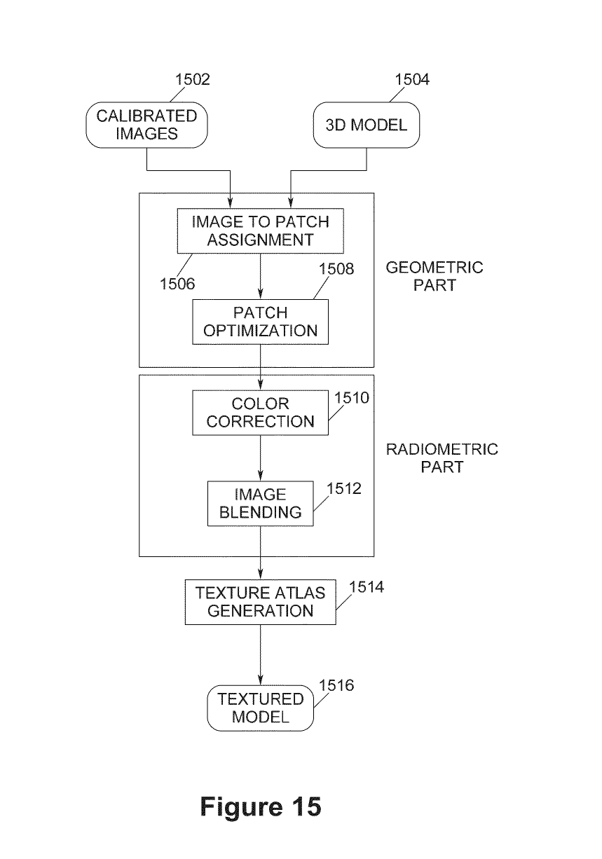

Further details of texture mapping/image blending processing 216 are as follows. Embodiments of the present invention comprise a general texture mapping framework for image-based 3D models. The framework comprises five steps, as shown in FIG. 15. The inputs are a 3D model M 1504, which consists of m faces, denoted as F=f₁, . . . , fₘ and n calibrated images I₁, . . . , Iₙ 1502. A geometric part of the framework comprises image to patch assignment block 1506 and patch optimization block 1508. A radiometric part of the framework comprises color correction block 1510 and image blending block 1512. At image to patch assignment 1506, the relationship between the images and the 3D model may be determined with the calibration matrices P₁, . . . , Pₙ. Before projecting a 3D point to 2D images, it is necessary to define visible faces in the 3D model from each camera. In an embodiment, an efficient hidden point removal process based on a convex hull may be used at patch optimization 1508. The central point of each face is used as the input to the process to determine the visibility for each face. Then the visible 3D faces can be projected onto images with Pᵢ. For the radiometric part, the color difference between every visible image on adjacent faces may be calculated at block 1510, which will be used in the following steps.

With the relationship between images and patches known, each face of the mesh may be assigned to one of the input views in which it is visible. The labeling process is to find a best set of l₁, . . . , lₘ (a labeling vector L={l₁, . . . , lₘ}) which enables the best visual quality and the smallest edge color difference between adjacent faces. Image blending 1512 compensates for intensity differences and other misalignments and the color correction phase lightens the visible seam between different texture fragments. Texture atlas generation 1514 assembles texture fragments into a single rectangular image, which improves the texture rendering efficiency and helps output portable 3D formats. Storing all of the source images for the 3D model would have a large cost in processing time and memory when rendering views from the blended images. The result of the texture mapping framework comprises textured model 1516. Textured model 1516 is used as for visualization and interaction by users, as well as stored in a 3D formatted model.

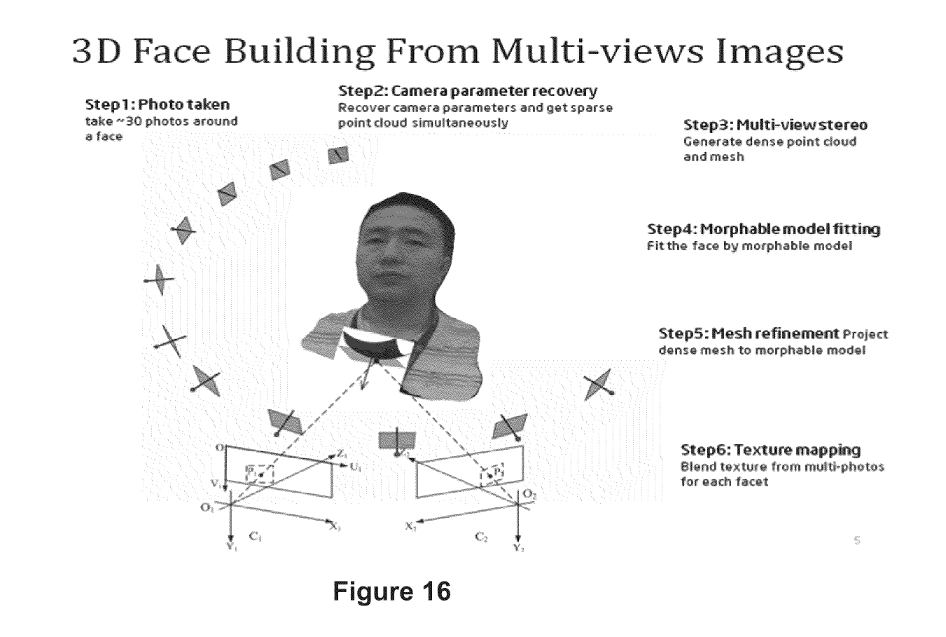

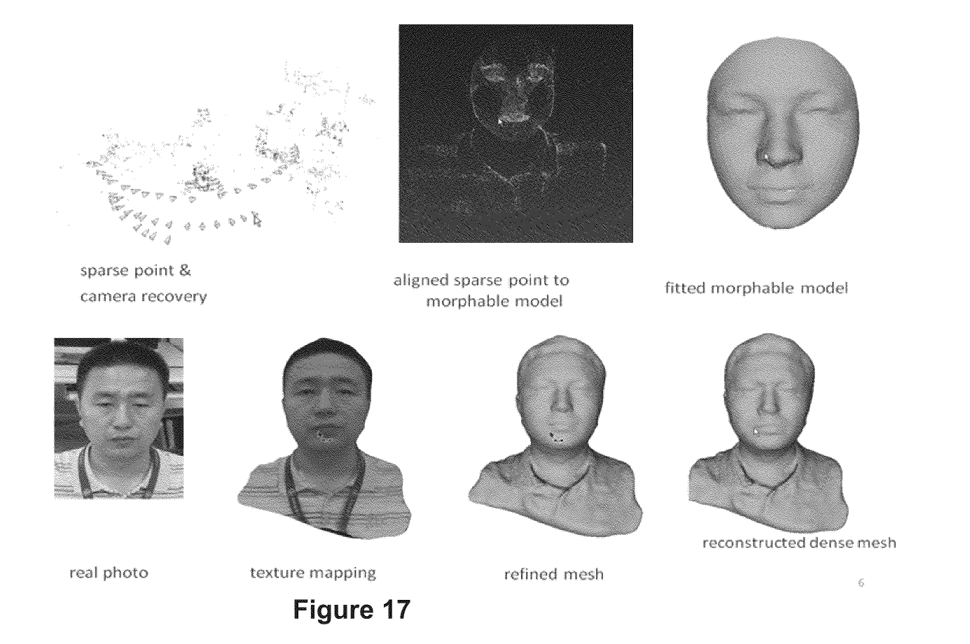

FIGS. 16 and 17 are example images illustrating 3D face building from multi-views images according to an embodiment of the present invention. At step 1 of FIG. 16, in an embodiment, approximately 30 photos around the face of the user may be taken. One of these images is shown as a real photo in the bottom left corner of FIG. 17. At step 2 of FIG. 16, camera parameters may be recovered and a sparse point cloud may be obtained simultaneously (as discussed above with reference to stereo matching 210). The sparse point cloud and camera recovery is represented as the sparse point cloud and camera recovery image as the next image going clockwise from the real photo in FIG. 17. At step 3 of FIG. 16, during multi-view stereo processing, a dense point cloud and mesh may be generated (as discussed above with reference to stereo matching 210). This is represented as the aligned sparse point to morphable model image as the next image continuing clockwise in FIG. 17. At step 4, the user's face from the image may be fit with a morphable model (as discussed above with reference to dense matching and bundle optimization 212). This is represented as the fitted morphable model image continuing clockwise in FIG. 17. At step 5, the dense mesh may be projected onto the morphable model (as discussed above with reference to dense matching and bundle optimization 212). This is represented as the reconstructed dense mesh image continuing clockwise in FIG. 17. Additionally, in step 5, the mesh may be refined to generate a refined mesh image as shown in the refined mesh image continuing clockwise in FIG. 17 (as discussed above with reference to denoising/orientation propagation 214). Finally, at step 6, texture from the multiple images may be blended for each face (as discussed above with reference to texture mapping/image blending 216). The final result example image is represented as the texture mapping image to the right of the real photo in FIG. 17.

Returning back to FIG. 2, the results of processing blocks 202-206 and blocks 210-216 comprise a set of avatar parameters 208. Avatar parameters may then be combined with generic 3D face model 104 to produce personalized facial components 106. Personalized facial components 106 comprise a 3D morphable model that is personalized for the user's face. This personalized 3D morphable model may be input to user interface application 220 for display to the user. The user interface application may accept user inputs to change, manipulate, and/or enhance selected features of the user's image. In an embodiment, each change as directed by a user input may result in re-computation of personalized facial components 218 in real time for display to the user. Hence, advanced HCI interactions may be provided by embodiments of the present invention. Embodiments of the present invention allow the user to interactively control changing selected individual facial features represented in the personalized 3D morphable model, regenerating the personalized 3D morphable model including the changed individual facial features in real time, and displaying the regenerated personalized 3D morphable model to the user.

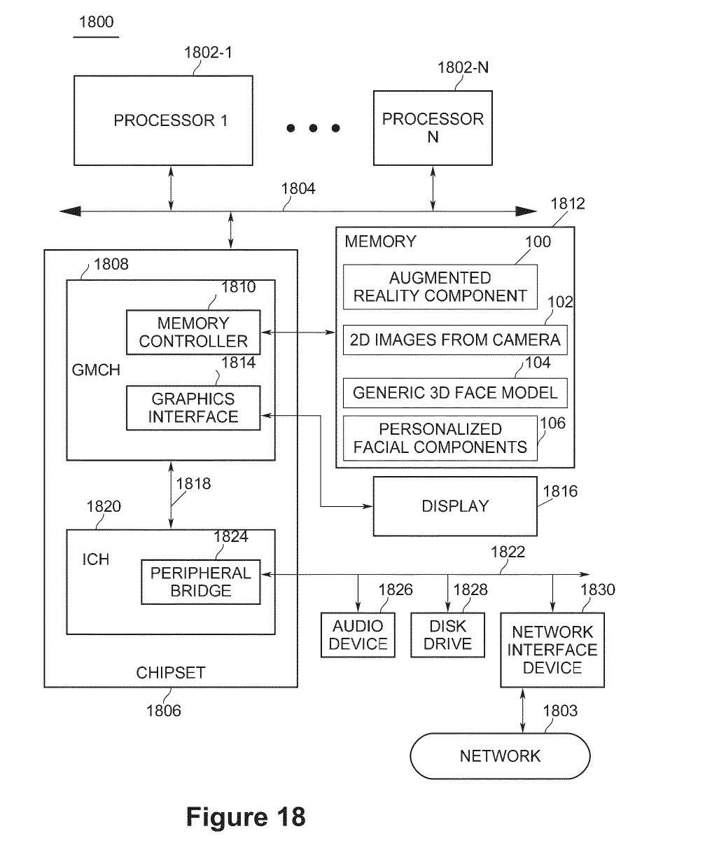

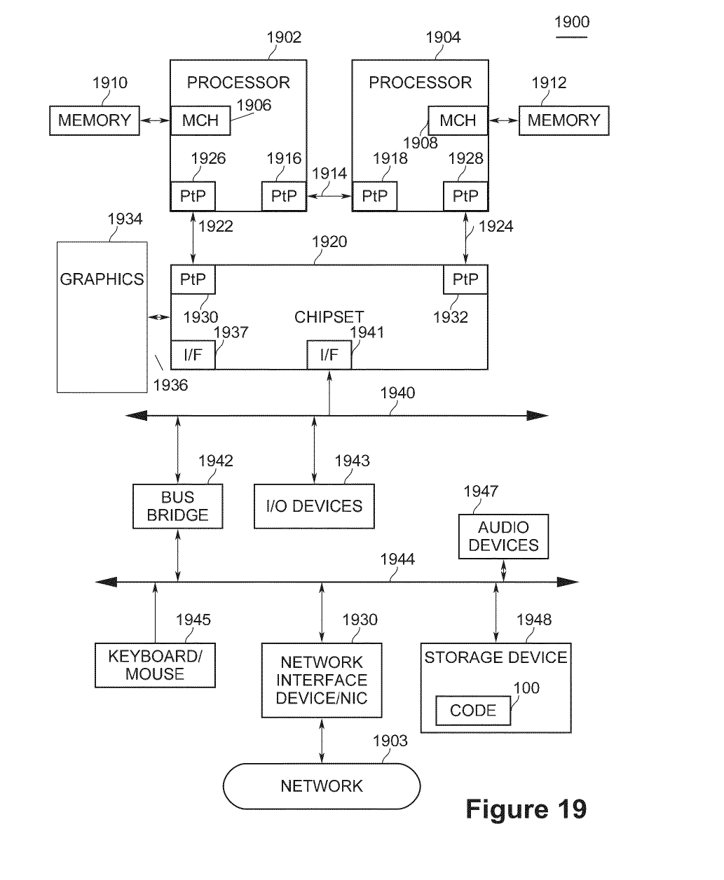

FIG. 18 illustrates a block diagram of an embodiment of a processing system 1800. In various embodiments, one or more of the components of the system 1800 may be provided in various electronic computing devices capable of performing one or more of the operations discussed herein with reference to some embodiments of the invention. For example, one or more of the components of the processing system 1800 may be used to perform the operations discussed with reference to FIGS. 1-17, e.g., by processing instructions, executing subroutines, etc. in accordance with the operations discussed herein. Also, various storage devices discussed herein (e.g., with reference to FIG. 18 and/or FIG. 19) may be used to store data, operation results, etc. In one embodiment, data (such as 2D images from camera 102 and generic 3D face model 104) received over the network 1803 (e.g., via network interface devices 1830 and/or 1930) may be stored in caches (e.g., L1 caches in an embodiment) present in processors 1802 (and/or 1902 of FIG. 19). These processors may then apply the operations discussed herein in accordance with various embodiments of the invention.

More particularly, processing system 1800 may include one or more processing unit(s) 1802 or processors that communicate via an interconnection network 1804. Hence, various operations discussed herein may be performed by a processor in some embodiments. Moreover, the processors 1802 may include a general purpose processor, a network processor (that processes data communicated over a computer network 1803, or other types of a processor (including a reduced instruction set computer (RISC) processor or a complex instruction set computer (CISC)). Moreover, the processors 702 may have a single or multiple core design. The processors 1802 with a multiple core design may integrate different types of processor cores on the same integrated circuit (IC) die. Also, the processors 1802 with a multiple core design may be implemented as symmetrical or asymmetrical multiprocessors. Moreover, the operations discussed with reference to FIGS. 1-17 may be performed by one or more components of the system 1800. In an embodiment, a processor (such as processor 1 1802-1) may comprise augmented reality component 100 and/or user interface application 220 as hardwired logic (e.g., circuitry) or microcode In an embodiment, multiple components shown in FIG. 18 may be included on a single integrated circuit (e.g., system on a chip (SOC).

A chipset 1806 may also communicate with the interconnection network 1804. The chipset 1806 may include a graphics and memory control hub (GMCH) 1808. The GMCH 1808 may include a memory controller 1810 that communicates with a memory 1812. The memory 1812 may store data, such as 2D images from camera 102, generic 3D face model 104, and personalized facial components 106. The data may include sequences of instructions that are executed by the processor 1802 or any other device included in the processing system 1800. Furthermore, memory 1812 may store one or more of the programs such as augmented reality component 100, instructions corresponding to executables, mappings, etc. The same or at least a portion of this data (including instructions, images, face models, and temporary storage arrays) may be stored in disk drive 1828 and/or one or more caches within processors 1802. In one embodiment of the invention, the memory 1812 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 1804, such as multiple processors and/or multiple system memories.

The GMCH 1808 may also include a graphics interface 1814 that communicates with a display 1816. In one embodiment of the invention, the graphics interface 1814 may communicate with the display 1816 via an accelerated graphics port (AGP). In an embodiment of the invention, the display 1816 may be a flat panel display that communicates with the graphics interface 1814 through, for example, a signal converter that translates a digital representation of an image stored in a storage device such as video memory or system memory into display signals that are interpreted and displayed by the display 1816. The display signals produced by the interface 1814 may pass through various control devices before being interpreted by and subsequently displayed on the display 1816. In an embodiment, 2D images, 3D face models, and personalized facial components processed by augmented reality component 100 may be shown on the display to a user.

A hub interface 1818 may allow the GMCH 1808 and an input/output (I/O) control huh (ICH) 1820 to communicate. The ICH 1820 may provide an interface to I/O devices that communicate with the processing system 1800. The ICH 1820 may communicate with a link 1822 through a peripheral bridge (or controller) 1824, such as a peripheral component interconnect (PCI) bridge, a universal serial bus (USB) controller, or other types of peripheral bridges or controllers. The bridge 1824 may provide a data path between the processor 1802 and peripheral devices. Other types of topologies may be utilized. Also, multiple buses may communicate with the ICH 1820, e.g., through multiple bridges or controllers. Moreover, other peripherals in communication with the ICH 1820 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The link 1822 may communicate with an audio device 1826, one or more disk drive(s) 1828, and a network interface device 1830, which may be in communication with the computer network 1803 (such as the Internet, for example). In an embodiment, the device 1830 may be a network interface controller (MC) capable of wired or wireless communication. Other devices may communicate via the link 1822. Also, various components (such as the network interface device 1830) may communicate with the GMCH 1808 in some embodiments of the invention. In addition, the processor 1802, the GMCH 1808, and/or the graphics interface 1814 may be combined to form a single chip. In an embodiment, 2D images 102, 3D face model 104, and/or augmented reality component 100 may be received from computer network 1803. In an embodiment, the augmented reality component may be a plug-in for a web browser executed by processor 1802.

Furthermore, the processing system 1800 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1828), a floppy disk, a compact disk ROM (CD-ROM), a digital versatile disk (DVD), flash memory, a magneto-optical disk, or other types of nonvolatile machine-readable media that are capable of storing electronic data including instructions).

In an embodiment, components of the system 1800 may be arranged in a point-to-point (PtP) configuration such as discussed with reference to FIG. 19. For example, processors, memory, and/or input/output devices may be interconnected by a number of point-to-point interfaces.

More specifically, FIG. 19 illustrates a processing system 1900 that is arranged in a point-to-point (PtP) configuration, according to an embodiment of the invention. In particular, FIG. 19 shows a system where processors, memory, and input/output devices are interconnected by a number of point-to-point interfaces. The operations discussed with reference to FIGS. 1-17 may be performed by one or more components of the system 1900.

As illustrated in FIG. 19, the system 1900 may include multiple processors, of which only two, processors 1902 and 1904 are shown for clarity. The processors 1902 and 1904 may each include a local memory controller hub (MCH) 1906 and 1908 (which may be the same or similar to the GMCH 1908 of FIG. 18 in some embodiments) to couple with memories 1910 and 1912. The memories 1910 and/or 1912 may store various data such as those discussed with reference to the memory 1812 of FIG. 18.

The processors 1902 and 1904 may be any suitable processor such as those discussed with reference to processors 802 of FIG. 18. The processors 1902 and 1904 may exchange data via a point-to-point (PtP) interface 1914 using PtP interface circuits 1916 and 1918, respectively. The processors 1902 and 1904 may each exchange data with a chipset 1920 via individual NP interfaces 1922 and 1924 using point to point interface circuits 1926, 1928, 1930, and 1932. The chipset 1920 may also exchange data with a high-performance graphics circuit 1934 via a high-performance graphics interface 1936, using a PtP interface circuit 1937.

At least one embodiment of the invention may be provided by utilizing the processors 1902 and 1904. For example, the processors 1902 and/or 1904 may perform one or more of the operations of FIGS. 1-17. Other embodiments of the invention, however, may exist in other circuits, logic units, or devices within the system 1900 of FIG. 19. Furthermore, other embodiments of the invention may be distributed throughout several circuits, logic units, or devices illustrated in FIG. 19.

The chipset 1920 may be coupled to a link 1940 using a PtP interface circuit 1941. The link 1940 may have one or more devices coupled to it, such as bridge 1942 and FO devices 1943. Via link 1944, the bridge 1943 may be coupled to other devices such as a keyboard/mouse 1945, the network interface device 1930 discussed with reference to FIG. 18 (such as modems, network interface cards (NICs), or the like that may be coupled to the computer network 1803), audio I/O device 1947, and/or a data storage device 1948. The data storage device 1948 may store, in an embodiment, augmented reality component code 100 that may be executed by the processors 1902 and/or 1904.

In various embodiments of the invention, the operations discussed herein, e.g., with reference to FIGS. 1-17, may be implemented as hardware (e.g., logic circuitry), software (including, for example, micro-code that controls the operations of a processor such as the processors discussed with reference to FIGS. 18 and 19), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1-23. (canceled)

24. A method of generating a personalized 3D morphable model of a user's face comprising:
capturing at least one 2D image of a scene by a camera;
detecting the user's face in the at least one 2D image;
detecting 2D landmark points of the user's face in the at least one 2D image;
registering each of the 2D landmark points to a generic 3D face model; and
generating in real time personalized facial components representing the user's face mapped to the generic 3D face model to form the personalized 3D morphable model, based at least in part on the 2D landmark points registered to the generic 3D face model.

25. The method of claim 24, further comprising displaying the personalized 3D morphable model to the user.

26. The method of claim 25, further comprising allowing the user to interactively control changing selected individual facial features represented in the personalized 3D morphable model, regenerating the personalized 3D morphable model including the changed individual facial features in real time, and displaying the regenerated personalized 3D morphable model to the user.

27. The method of claim 25, further comprising repeating the capturing, detecting the user's face, detecting the 2D landmark points, registering, and generating steps in real time fur a sequence of 2D images as live video frames captured from the camera, and displaying successively generated personalized 3D morphable models to the user.

28. A system to generate a personalized 3D morphable model representing a user's face comprising:
a 2D landmark points detection component to accept at least one 2D image from a camera, the at least one 2D image including a representation of the user's face, and to detect 2D landmark points of the user's face in the at least one 2D image;
a 3D facial part characterization component to accept a generic 3D face model and to facilitate the user to interact with segmented 3D face regions;
a 3D landmark points registration component, coupled to the 2D landmark points detection component and the 3D facial part characterization component, to accept the generic 3D face model and the 2D landmark points, to register each of the 2D landmark points to the generic 3D face model, and to estimate a re-projection error in registering each of the 2D landmark points to the generic 3D face model; and
a personalized avatar generation component, coupled to the 2D landmark points detection component and the 3D landmark points registration component, to accept the at least one 2D image from the camera, the one or more 2D landmark points as registered to the generic 3D face model, and the re-projection error, and to generate in real time personalized facial components representing the user's face mapped to the 3D personalized morphable model.

29. The system of claim 28, wherein the user interactively controls changing in real time selected individual facial features represented in the personalized facial components mapped to the personalized 3D morphable model.

30. The system of claim 28, wherein the personalized avatar generation component comprises a face detection component to detect at least one user's face in the at least one 2D image from the camera.

31. The system of claim 30, wherein the face detection component is to detect a position and size of each detected face in the at least one 2D image.

32. The system of claim 28, wherein the 2D landmark points detection component is to estimate transformation of and align correspondence of 2D landmark points detected in multiple 2D images.

33. The system of claim 28, wherein the 2D landmark points comprise locations of at least one of eye corners and mouth corners of the user's face represented in the at least one 2D image.

34. The system of claim 28, wherein the personalized avatar generation component comprises a stereo matching component to perform stereo matching for a pair of 2D images to recover a camera pose of the user.

35. The system of claim 28, wherein the personalized avatar generation component comprises a dense matching and bundle optimization component to rectify a pair of 2D images such that an epipolar line corresponds to a scan line, based at least in part on calibrated camera parameters.

36. The system of claim 28, wherein the personalized avatar generation component comprises a denoising/orientation propagation component to smooth the 3D personalized morphable model and enhance the shape geometry.

37. The system of claim 28, wherein the personalized avatar generation component comprises a texture mapping/image blending component to produce avatar parameters representing the user's face to generate a photorealistic effect for each individual user.

38. The system of claim 37, wherein the personalized avatar generation component maps the avatar parameters to the generic 3D face model to generate the personalized facial components.

39. The system of claim 28, further comprising a user interface application component to display the personalized 3D morphable model to the user.

40. A method of generating a personalized 3D morphable model representing a user's face, comprising:
accepting at least one 2D image from a camera, the at least one 2D image including a representation of the user's face;
detecting the user's face in the at least one 2D image;
detecting 2D landmark points of the detected user's face in the at least one 2D image;
accepting a generic 3D face model and the 2D landmark points, registering each of the 2D landmark points to the generic 3D face model, and estimating a re-projection error in registering each of the 2D landmark points to the generic 3D face model;
performing stereo matching for a pair of 2D images to recover a camera pose of the user;
performing dense matching and bundle optimization operations to rectify a pair of 2D images such that an epipolar line corresponds to a scan tine, based at least in part on calibrated camera parameters;
performing denoising/orientation propagation operations to represent the personalized 3D morphable model with an adequate number of point clouds while depicting an geometry shape having a similar appearance;
performing texture mapping/image blending operations to produce avatar parameters representing the user's face to enhance the visual effect of the avatar parameters to be photo-realistic under various lighting conditions and viewing angles;
mapping the avatar parameters to the generic 3D face model to generate the personalized facial components; and
generating in real time the personalized 3D morphable model east in part from the personalized facial components.

41. The method of claim 40, further comprising displaying the personalized 3D morphable model to the user.

42. The method of claim 41, further comprising allowing the user to interactively control changing selected individual facial features represented in the personalized 3D morphable model, regenerating the personalized 3D morphable model including the changed individual facial features in real time, and displaying the regenerated personalized 3D morphable model to the user.

43. The method of claim 40, further comprising estimating transformation of and alignment correspondence of 2D landmark points detected in multiple 2D images.

44. The method of claim 40, further comprising repeating the steps of claim 40 in real time for a sequence of 2D images as live video frames captured from the camera, and displaying successively generated personalized 3D morphable models to the user.

45. Machine-readable instructions arranged, when executed, to implement a method or realize an apparatus as claimed in any preceding claim.

46. Machine-readable storage storing machine-readable instructions as claimed in claim 45.
